(19) United States
(12) Patent Application Publication
(10) Pub. No.: US 2026/0080019 A1
(43) Pub. Date: Mar. 19, 2026

(54) GEOLOGIC AND GEOPHYSICS DATA MINER

(71) Applicant: Schlumberger Technology Corporation, Sugar Land, TX (US)

(72) Inventors: Thiago Couto De Almeida Chaves, Rio de Janeiro (BR); Rodrigo Bittencourt de Aguiar, Rio de Janeiro (BR)

(21) Appl. No.: 19/328,593

(22) Filed: Sep. 15, 2025

Related U.S. Application Data
(60) Provisional application No. 63/694,262, filed on Sep. 13, 2024.

(51) Int. Cl. G06F 16/908; G01V 1/30; G06F 16/9038

(52) U.S. Cl. CPC G06F 16/908; G01V 1/30; G06F 16/9038; G01V 2210/612

(57) ABSTRACT

Systems, computer-readable media, and methods, of which a method includes receiving data representing one or more oilfield projects, extracting the metadata from the data representing the one or more oilfield projects using one or more virtual machines, determining enriched metadata based on the metadata, storing the data, including the metadata and the enriched metadata, in one or more repositories, searching the metadata in the one or more repositories to find data representing a subterranean feature of interest within the data, returning results of the searching, the results based at least in part on the metadata and the enriched metadata.

### CROSS-REFERENCE TO RELATED APPLICATIONS

This application claims priority to U.S. Provisional Patent Application having Ser. No. 63/694,262, which was filed on Sep. 13, 2024, and is incorporated herein by reference in its entirety.

### BACKGROUND

Massive amounts of data are collected during oilfield projects, from exploration, to modeling, planning, drilling, and production. Managing this data and providing for its quick access, so its value can be effectively leveraged in new or ongoing projects, can present challenges. Recently, many industry participants have begun transitioning their data to the Open Subsurface Data Universe (OSDU) platform. The OSDU platform provides a vendor-neutral, standards-based environment for exploration and production processing, facilitating cross-industry collaboration. For this migration to proceed seamlessly, the data generally undergoes a meticulous evaluation and classification before commencing the migration process. Large repositories can include data for thousands of oilfield projects, which can include numerous inconsistencies and/or redundancies. Accordingly, retention/migration of some of this data may not be called for.

### SUMMARY

In an example, a method includes receiving data representing one or more oilfield projects, extracting the metadata from the data representing the one or more oilfield projects using one or more virtual machines, determining enriched metadata based on the metadata, storing the data, including the metadata and the enriched metadata, in one or more repositories, searching the metadata in the one or more repositories to find data representing a subterranean feature of interest within the data, and returning results of the searching, the results based at least in part on the metadata and the enriched metadata.

In an example, a computing system includes one or more processors, and a memory system having one or more non-transitory computer-readable media storing instructions that, when executed by at least one of the one or more processors, cause the computing system to perform operations. The operations include receiving data representing one or more oilfield projects, the data comprising metadata representing at least one of a history of changes of a subterranean object, or a statistic representing the object, a quality attribute including at least one of completeness, unicity, or accuracy of the data, or a combination thereof, extracting the metadata from the data representing the one or more oilfield projects using one or more virtual machines, storing the data, including the metadata, in a repository, and searching, using one or more filters, the metadata in the repository to find data representing a subterranean feature of interest within the data.

In an example, a non-transitory computer-readable medium is provided, which stores instructions that, when executed by one or more processors of a computing system, cause the computing system to perform operations. The operations include receiving data representing one or more oilfield projects, extracting the metadata from the data representing the one or more oilfield projects using one or more virtual machines, determining enriched metadata based on the metadata, storing the data, including the metadata, in a repository, searching the metadata in the repository to find data representing a subterranean feature of interest within the data, and returning results of the searching, the results based at least in part on the metadata and the enriched metadata. The data represents an individual feature, wherein the metadata represents one or more aspects of the data, and the enriched metadata represents data about a subsurface region based on metadata representing multiple objects.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate examples of the present teachings and together with the description, serve to explain the principles of the present teachings. In the figures:

FIG. 1 illustrates an example of a system that includes various management components to manage various aspects of a geologic environment, according to an example.

FIG. 2 illustrates a schematic view of a project platform, according to an example.

FIG. 3 illustrates a flowchart of a method, according to an example.

FIG. 4 illustrates a schematic view of a system for implementing the method of FIG. 3 within the platform of FIG. 2, according to an example.

FIG. 5 illustrates a schematic view of a computing system, according to an example.

### DETAILED DESCRIPTION

The geologic and geophysics (G&G) data miner described herein, according to an example, may be a cloud-native application designed for E&P environments (e.g., DELFI® commercially available from Schlumberger) that leverages various applications (e.g., DELFI® Technical Suites) to extract metadata from PETREL® projects and create a metadata database where metadata will be available to the user. This may permit enhanced oversight of the health and integrity of these objects.

This metadata may be generated or “liberated” from within the project files for use in multiple interfaces, enabling different workflows. Specific examples of such workflows include a G&G data miner portal, which may perform data management tasks; Dataiku, enabling advanced Artificial Intelligence workflows; and/or Tibco Spotfire, empowering Business Intelligence insights for management staff.

Reference will now be made in detail to examples, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the examples.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular examples and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining”or “in response to detecting,”depending on the context.

Attention is now directed to processing procedures, methods, techniques, and workflows that are in accordance with some examples. Some operations in the processing procedures, methods, techniques, and workflows disclosed herein may be combined and/or the order of some operations may be changed.

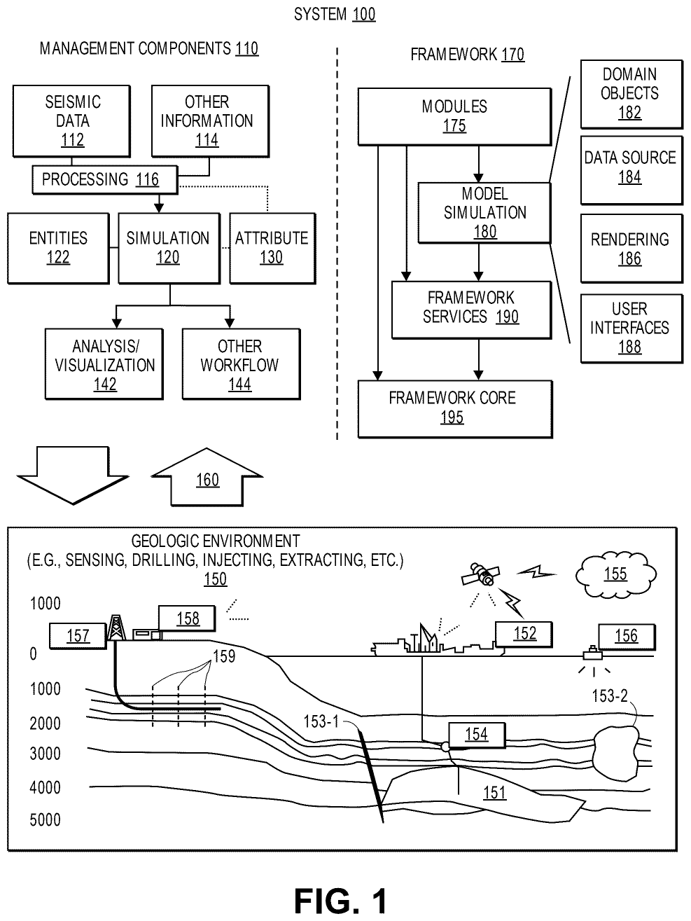

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

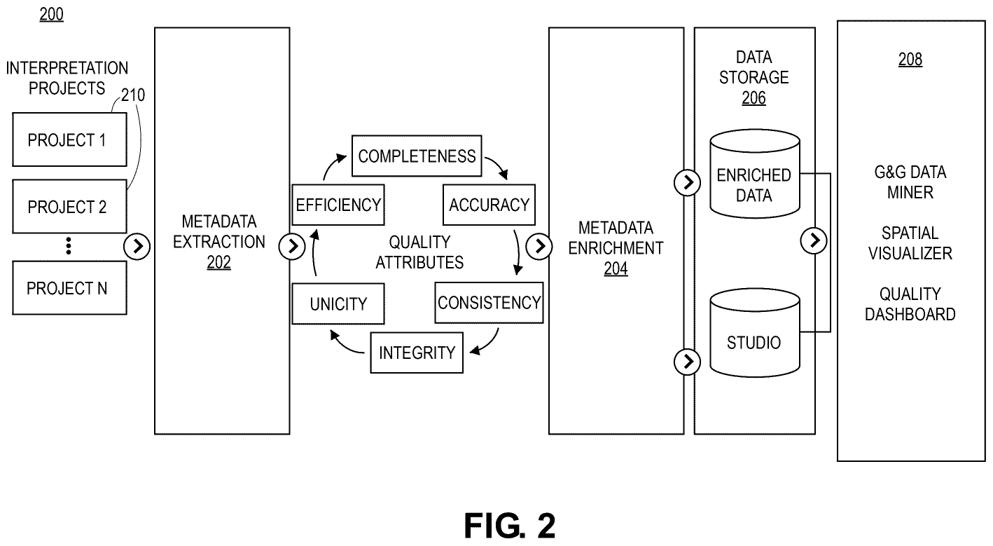

FIG. 2 illustrates a schematic view of an oilfield data processing environment 200, according to an example. The environment 200 may be hosted and/or executed by one or more processing platforms, using hardware such as processors, servers, etc., as will be described in greater detail below. The environment 200 generally includes a metadata extraction module 202, a metadata enrichment module 204, a data storage 206, and one or more applications modules 208 (e.g., Geology and Geophysics DataMiner (commercially available through Schlumberger) spatial visualizer, and/or quality dashboard). Enriched data may be segregated and stored separately from project data, as represented by the two databases in block 206.

The environment 200 may be provided with projects 210, which may include data representing, for example, a subsurface volume of interest for the projects 210. Such data may include geological, geophysical, stratigraphic, or any other type of subsurface data. Such data may also or instead include data representing other oilfield activities, such as drilling systems, completion systems, production systems, other exploration systems, etc.

The projects 210 may also include metadata representing aspects of the data, history of the data, etc. The metadata extraction module 204 may retrieve, generate, or otherwise collect metadata from the projects 210, which may be analyzed/interpolated, or otherwise enriched in the metadata enrichment module 208, as will be described in greater detail below.

More particularly, each project 210 may include metadata within the project file. Such metadata may represent objects of a subterranean domain, e.g., geological features. The oilfield projects may be configured to collect data representing these geological features, and the metadata may represent data providing further information related to the objects. The metadata may, for example, provide a history of changes of a subterranean object, a statistic representing the object, etc. The metadata may also provide basic information about the subterranean objects contained in the project, such as the name, any description (qualitative or quantitative), comments or anything else that gives a basic characterization of the object.

Such metadata may be stored in a particular way which may give meaning to the data stored therein. For example, metadata related to a geological object such as a horizon may be named in a specific way. The name may specify features of the geological object, such as its depth, direction, location, orientation, etc. For example, in a geological or geophysical model of a subsurface volume, a horizon may be modeled therein. The horizon in the model may be the raw data. Various features of the horizon may be metadata, such as representations of area, location, history of changes, changes in amplitude, etc. These features may be represented in the name in a particular, e.g., standardized (within the processing platform) manner, using an agreed-upon format that is quickly decipherable to another user or program. The primary data as well as the metadata may then be stored in the data storage 206 for later retrieval as part of execution of one or more of the applications in the applications module 208.

Various quality metrics may be calculated from the metadata. As shown, for example, the quality features of the projects 210 represented by the metadata may include indications (e.g., scores, descriptions of, etc.) completeness of a feature or model thereof, accuracy of the feature in the model, consistency of the model, model integrity, unicity, interpretability, temporality, completeness, and efficiency.

The quality attributes may be representative of individual features, of a portion (e.g., region or attribute) of the model, or the model as a whole. For example, quality attributes of the metadata may identify whether a horizon is “good” or “bad”, which may be used to filter the horizon as a result for a user searching for information useful in another project. A “good” horizon may be one that is more useful for later analysis (e.g., of another, similar geological area), as its data may be more reliable, and may thus be presented more frequently or higher on a list of results. A “bad” horizon may be retrieved less frequently for use, or pushed lower in a series of results, as it may be less reliable. Such “good” versus “bad” judgment may be relative and determined based on accuracy, following domain rules (e.g., filename conventions), model quality, fidelity, etc., e.g., at least partially based on the quality attributes. Additionally, the quality attributes may be determined from the metadata but relate to the object itself. For example, the name of a horizon does not follow the standard, the data represent the horizon may be assumed to be less reliable.

The metadata enrichment module 204 may use the metadata from multiple projects and/or multiple objects within individual projects to determine additional metadata, e.g., data about the metadata itself. For example, continuing with the stratigraphic example of the horizon in the subsurface area of interest, the data about multiple horizons, selected at least partially based on quality attributes, may be used to quickly present data about the stratigraphy of a larger area. This may permit larger areas or regions based on the stratigraphic data representing individual horizons or other features. In at least some embodiments, the enriched metadata is calculated based on the metadata and is not based directly on the data. That is, in at least some embodiments, the enriched metadata may provide information about a domain (area, region, etc.) that is determined based on the project data representing the objects therein, but the enriched data may not provide any information directly about any individual object, or even any individual project. Rather, the enriched data may provide information more broadly about a classification of a region of interest (e.g., its geology, how well the subsurface area is understood/modeled, etc.).

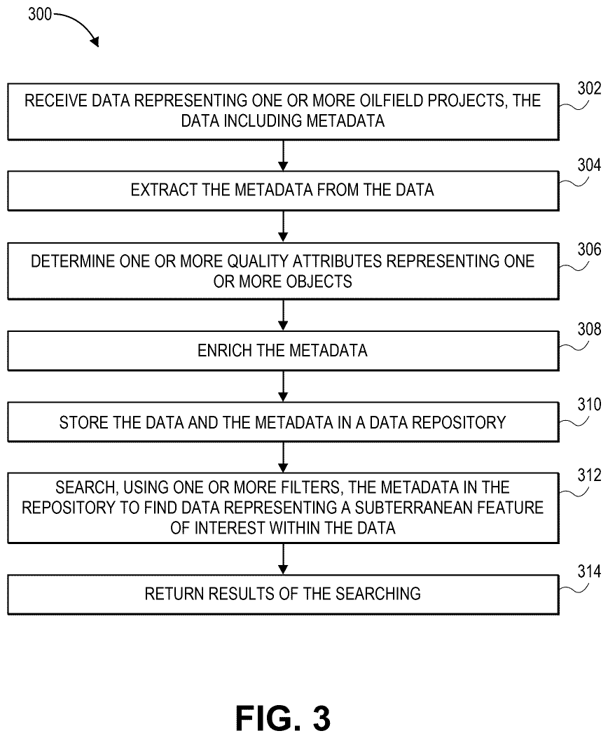

FIG. 3 illustrates a flowchart of a method 300, according to an example. The method 300 may include receiving data representing one or more oilfield projects, as at 302. Along with primary data (data representing the underlying object), the data may include metadata, which is data that represents the data itself. Indeed, apart from the primary data, these projects may yield a wealth of valuable information in the form of metadata. Metadata serves multiple functions, including data discovery, enabling intelligent search capabilities, and facilitating its integration into the OSDU data schema, among other uses. To leverage this metadata, the method 300 may be configured to accurately extract, enrich and store such metadata, enabling users to utilize it in both targeted data queries and providing a platform for intelligence for data scientists. Examples of such metadata may include a history of changes of a subterranean object, a statistic representing the object, a quality control attribute comprising at least one of completeness, unicity, or accuracy of the data, or a combination thereof.

Accordingly, the method 300 may also include extracting the metadata from the data representing the oilfield projects using one or more virtual machines, as at 304. Additional details of the virtual machines employed within an overall system are provided below.

The method 300 may include determining one or more quality attributes representing one or more objects of the oilfield projects, as at 306. As discussed above, the quality attributes may include completeness, accuracy, consistency, integrity, unicity, interpretability, temporality, and/or efficiency. The quality attributes may be metadata that represent the reliability of primary data representing the objects in the projects. For example, this metadata may be stored and quickly retrieved as part of a name of an object in a database.

The method 300 may also include enriching the metadata, as at 308. Enriching at 308 may include making inferences about classifications of an area, which may be represented by one, two, or more of the projects, from the metadata representing the individual objects. In general terms, “metadata enrichment” refers to making calculations, determinations, or inferences from metadata. For example, the stratigraphy (or even a lack of stratigraphic information or model completeness) may be determined as enriched metadata based on a review and analysis of available metadata.

The method 300 may also include storing the data, including the metadata, in a repository, as at 310. The enriched metadata may be stored separately from project data. The method 300 may include searching, using one or more filters, the metadata in the repository to find data representing a subterranean feature of interest within the data, as at 312. The results may be provided, as at 314. The results may be sorted (e.g. ranked), filtered (some selected and some excluded) based at least in part on one or more of the quality attributes.

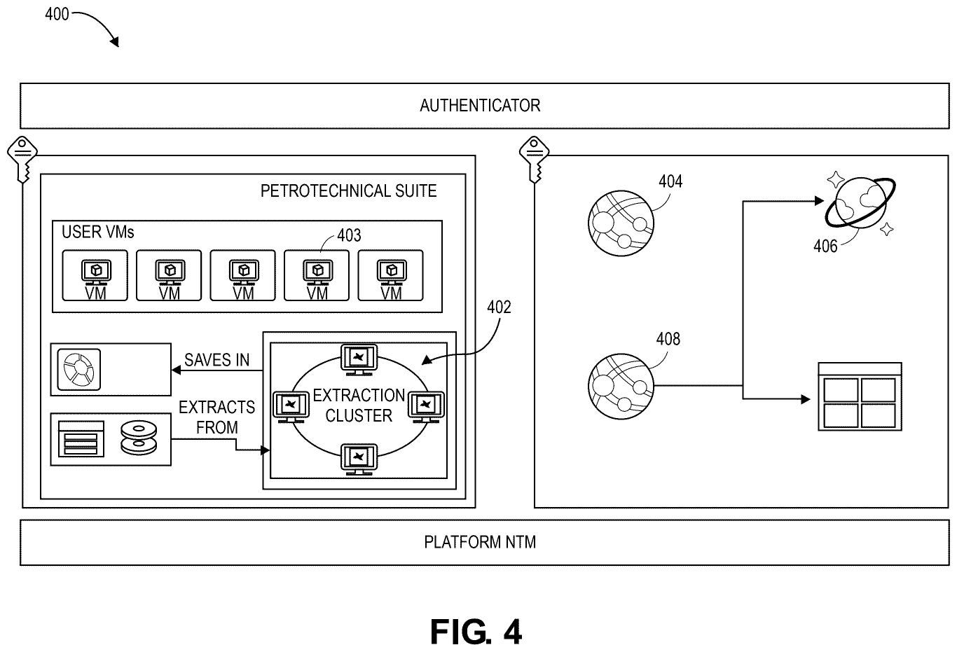

FIG. 4 illustrates a schematic view of a system 400 for implementing the method 300 of FIG. 3, e.g., as part of the system 200 of FIG. 2, according to an example. The system 400 may be stored and/or executed on one or more remote servers, e.g., the cloud, and may be integrated within an oilfield services platform (e.g., DELFI®). The system 400 and method 300 may be tailored for identifying and extracting subsurface features of interest, such as, for example, horizons. Any other type of geological or other subsurface features or object may also be identified/extracted according to examples of the present disclosure.

The system 400 may include an extraction cluster 402. The cluster 402 includes virtual machines 403 with an exploration and production platform (e.g., PETREL®) and/or other oilfield data platform installation and a custom agent. Each machine has the ability to extract metadata from the projects and to execute custom workflows inside Petrel. This gives the user the capacity for executing workflows at scale, and resulting data may be published for future retrieval.

The system 400 also includes a G&G data miner portal 404. This may be a web app. The user can interact with the metadata database via the portal 404 (e.g., via one or more APIs). For example, the user can apply a combination of filters, based on enriched metadata, to quickly find an appropriate horizon (or other type of feature). To support the search, the user may have access to the full history of changes to this object, statistics, and quality control attributes such as: completeness, accuracy, consistency, integrity, unicity, interpretability, temporality, and/or efficiency, etc. Through the app, workflows can be configured, such as the extractor workflow, creating a new extraction job for a subset of projects, configuring the frequency of execution, etc.

The system 400 includes one or more data repositories 406. Both the data stored in Studio and the metadata database can be made readily accessible to users, such as interpreters and data scientists. This data can be accessed through a variety of platforms, including Dataiku, TIBCO, and others. As the data migration process to the OSDU platform gets underway, the combined power of both databases, Studio, and the metadata database can be harnessed to seamlessly amalgamate the data and ensure its proper formatting and storage.

The system 400 further includes a geospatial viewer 408, which may be an interactive viewer based on TIBCO Spotfire (or another platform). The viewer 408 may provide a comprehensive, interactive geospatial view of the stored data to provide a bird's eye view of the extracted horizon objects (and/or other subsurface features of interest). It will be appreciated that Spotfire may not be an Azure App Service application, although it may be. Similarly, the Geology and Geophysical DataMiner API may be an Azure App Service application or integrated into another such application.

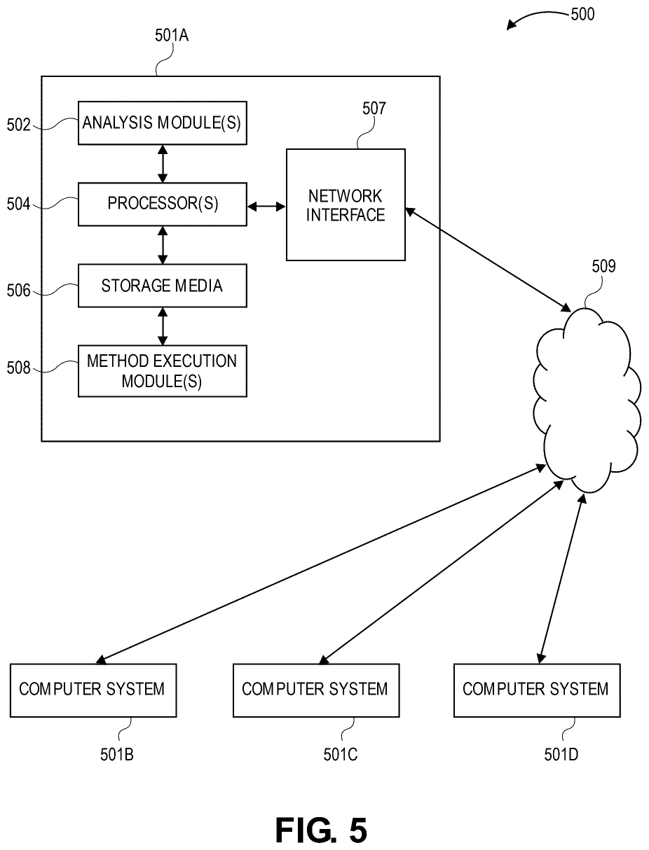

In some examples, the methods of the present disclosure may be executed by a computing system. FIG. 5 illustrates an example of such a computing system 500, in accordance with some examples. The computing system 500 may include a computer or computer system 501A, which may be an individual computer system 501A or an arrangement of distributed computer systems. The computer system 501A includes one or more analysis modules 502 that are configured to perform various tasks according to some examples, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example of FIG. 5 storage media 506 is depicted as within computer system 501A, in some examples, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some examples, computing system 500 contains one or more project migration module(s) 508. In the example of computing system 500, computer system 501A includes the project migration module 508. In some examples, a single project migration module may be used to perform some aspects of one or more examples of the methods disclosed herein. In other examples, a plurality of project migration modules may be used to perform some aspects of methods herein.

It should be appreciated that computing system 500 is merely one example of a computing system, and that computing system 500 may have more or fewer components than shown, may combine additional components not depicted in the example of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific examples. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The examples were chosen and described in order to best explain the principles of the disclosure and its practical applications, to thereby enable others skilled in the art to best utilize the disclosed examples and various examples with various modifications as are suited to the particular use contemplated.

What is claimed is:

1. A method, comprising:
receiving data representing one or more oilfield projects;
extracting the metadata from the data representing the one or more oilfield projects using one or more virtual machines;
determining enriched metadata based on the metadata;
storing the data, including the metadata and the enriched metadata, in one or more repositories;
searching the metadata in the one or more repositories to find data representing a subterranean feature of interest within the data; and
returning results of the searching, the results based at least in part on the metadata and the enriched metadata.

2. The method of claim 1, further comprising determining one or more quality attributes of the data based at least in part on the metadata, and wherein the results are based at least partially on the quality attributes.

3. The method of claim 2, wherein the one or more quality attributes comprise completeness, accuracy, consistency, integrity, unicity, and efficiency of data representing an object represented in the data representing the one or more oilfield projects.

4. The method of claim 1, wherein the metadata represents at least one of:
a history of changes of a subterranean object, or
information about the subterranean object comprising at least one of a name of the object, a description of the object, or user-defined comments relating to the object;
or a combination thereof.

5. The method of claim 1, wherein the enriched metadata represents a subterranean volume including a plurality of objects, and wherein the plurality of objects are represented by data in a plurality of projects, respectively.

6. The method of claim 5, wherein the enriched metadata is calculated based on the metadata.

7. The method of claim 5, further comprising calculating a quality attribute for the subterranean object, based on at least one of accuracy, completeness, consistency, efficiency, interpretability, or temporality of the object.

8. The method of claim 5, wherein the data represents an individual feature, wherein the metadata represents one or more aspects of the data, and wherein the enriched metadata represents data about a subsurface region based on metadata representing multiple objects.

9. A computing system, comprising:
one or more processors; and
a memory system comprising one or more non-transitory computer-readable media storing instructions that, when executed by at least one of the one or more processors, cause the computing system to perform operations, the operations comprising:
receiving data representing one or more oilfield projects, the data comprising metadata representing at least one of:
a history of changes of a subterranean object, or
a statistic representing the object, a quality attribute comprising at least one of completeness, unicity, or accuracy of the data, or
a combination thereof;
extracting the metadata from the data representing the one or more oilfield projects using one or more virtual machines;
storing the data, including the metadata, in a repository; and
searching, using one or more filters, the metadata in the repository to find data representing a subterranean feature of interest within the data.

10. The system of claim 9, further comprising:
determining enriched metadata based on the metadata; and
returning results of the searching, the results based at least in part on the metadata and the enriched metadata.

11. The system of claim 10, wherein the operations further comprise determining the quality attribute of the data based at least in part on the metadata, and wherein the results are based at least partially on the quality attributes.

12. The system of claim 10, wherein the enriched metadata represents a subterranean volume including a plurality of objects, and wherein the plurality of objects are represented by data in a plurality of projects, respectively.

13. The system of claim 10, wherein the enriched metadata is calculated based on the metadata.

14. The system of claim 13, wherein the data represents a geological feature and the enriched metadata represents a region that includes the geological feature.

15. The method of claim 10 wherein the data represents an individual feature, wherein the metadata represents one or more aspects of the data, and wherein the enriched metadata represents data about a subsurface region based on metadata representing multiple objects.

16. A non-transitory computer-readable medium storing instructions that, when executed by one or more processors of a computing system, cause the computing system to perform operations, the operations comprising:
receiving data representing one or more oilfield projects;
extracting the metadata from the data representing the one or more oilfield projects using one or more virtual machines;
determining enriched metadata based on the metadata;
storing the data, including the metadata, in a repository;
searching the metadata in the repository to find data representing a subterranean feature of interest within the data; and
returning results of the searching, the results based at least in part on the metadata and the enriched metadata,
wherein the data represents an individual feature, wherein the metadata represents one or more aspects of the data, and wherein the enriched metadata represents data about a subsurface region based on metadata representing multiple objects.

17. The medium of claim 16, wherein the operations further comprise determining one or more quality attributes of the data based at least in part on the metadata, and wherein the results are based at least partially on the quality attributes.

18. The medium of claim 17, wherein the one or more quality attributes comprise calculating a quality attribute for the subterranean object, based on at least one of accuracy, completeness, consistency, efficiency, interpretability, or temporality of the data representing an object in one of the one or more oilfield projects.

19. The medium of claim 16, wherein the metadata represents at least one of:
a history of changes of a subterranean object,
information about the subterranean object comprising at least one of a name of the object, a description of the object, or user-defined comments relating to the object;
a combination thereof.

20. The medium of claim 19, wherein the enriched metadata represents a subterranean volume including a plurality of objects, wherein the plurality of objects are represented by data in a plurality of projects, respectively.
